(19) United States
(12) Patent Application Publication
(10) Pub. No.: US 2022/0251339 A1
(43) Pub. Date: Aug. 11, 2022

(54) SILICA REINFORCED THERMOPLASTIC POLYURETHANES

(71) Applicant: Cabot Corporation, Boston, MA (US)

(72) Inventors: Eugene N. Step, Newton, MA (US); Angelica M. Sanchez Garcia, Somerville, MA (US); Marc B. Delvaux, Liege (BE); Vahid Sendijarevic, Troy, MI (US); Aisa Sendijarevic, Troy, MI (US); Ibrahim Sendijarevic, Bloomfield Hills, MI (US)

(21) Appl. No.: 17/591,853

(22) Filed: Feb. 3, 2022

Related U.S. Application Data
(60) Provisional application No. 63/147,910, filed on Feb. 10, 2021.
(60) Provisional application No. 63/234,442, filed on Aug. 18, 2021.

(51) Int. Cl. C08K 9/06; C08G 18/12; C08G 18/24; C08G 18/48; C08G 18/32; C08G 18/76

(52) U.S. Cl. CPC C08K 9/06; C08G 18/12; C08G 18/242; C08K 2201/006; C08G 18/3206; C08G 18/3203; C08G 18/7671; C08G 18/4845

(57) ABSTRACT

Hydrophobic silica is combined with a polyether in an in situ process for producing thermoplastic polyurethane with superior mechanical properties. The resulting thermoplastic polyurethane may be used in a variety of applications, including midsoles and outsoles in footwear and in wire insulation, hoses, films, wheels and tires, and drilling/mining screens.

This application claims priority from US Provisional Applications Nos. 63/147,910, filed Feb. 10, 2021, and 63/234,442, filed Aug. 18, 2021, the entire contents of both of which are incorporated herein by reference.

### BACKGROUND OF THE INVENTION

### 1. Field of the Invention

This invention relates to thermoplastic polyurethanes reinforced with hydrophobic fumed silica.

### 2. Description of the Related Art

The term “polyurethane” describes a wide variety of polymer compositions. Each of these polymer compositions contains polymers whose repeating units include —N—CO—O— linkages. In addition, polyurethanes may also include urea (—N—CO—N—) linkages However, the composition of the molecular chains between these urethane and urea linkages and the method of making the polymer also influence the final properties. Thus, polyurethanes with different compositions and/or made by different methods are used in diverse applications ranging from adhesives to coatings to elastomers to different types of foams. In general, polyurethanes are produced by the reaction of a polyisocyanate with a polyol.

Polyurethanes are versatile materials whose chemistry may be varied for use in a variety of forms, including adhesives, coatings, foams, and dense thermoplastics. To form thermoplastic polyurethanes, two different polyols are typically used to create block co-polymers. For example, low molecular weight glycols and diisocyanates result in the formation of short chains that associate through hydrogen bonding to form a hard phase that may be crystalline. A second, “softer” block may be formed with the use of polyether or polyester polyols, which result in amorphous domains. The properties of the thermoplastic polyurethane (TPU) are dictated by the morphology of the two domains. The hard domains, or phase, act as a filler to provide reinforcement and allow the otherwise elastomeric TPU to be processed using plastic processing equipment rather than rubber processing equipment, while the TPU material still behaves as an elastomer under strain. The tensile properties of the polymer are dictated by how tensile forces interfere with the hydrogen bonding in the hard domains.

A variety of fillers are commonly employed in polyurethanes to modify their mechanical, electrical, and other properties. These fillers may be combined with the polymerized material, for example, via melt mixing, or incorporated into the prepolymer composition prior to polycondensation in an in-situ process. Fillers that are employed in an in-situ process must fulfill two functions. Not only do they need to provide desired properties to the finished product, but they also cannot interfere with the polymerization to generate that product.

WO2012069264 discloses methods and formulations for incorporating fumed silica, including both hydrophilic and hydrophobic fumed silica, in thermoplastic polyurethanes. However, it is desirable to better optimize the influence of the hydrophobic silica on the polymerization and final properties of the polyurethane material.

### SUMMARY OF THE INVENTION

In one embodiment, a method of producing thermoplastic polyurethane includes providing a polyol composition comprising at least a first polyol, the first polyol having a number average molecular weight of 300 to 5000, and up to 15 wt % of a fumed silica having a surface area of at least 50 m²/g, wherein the fumed silica has C1-C8 alkylsilyl groups or acrylate or methacrylate ester groups at its surface, combining the polyol composition and an aromatic, cycloaliphatic, or araliphatic diisocyanate to form a prepolymer composition, and allowing the prepolymer composition to polymerize to form a thermoplastic polyurethane having a density no less than 0.8 g/mL. The thermoplastic polyurethane may be molded.

Allowing may include adding a catalyst to the prepolymer composition. The prepolymer composition further comprises a chain extender. The fumed silica may have a surface area of 50 to 400 m²/g. The fumed silica may have C1-C3 alkylsilyl groups on the surface.

The thermoplastic polyurethane composition may have an elongation at break that is higher than that of a control thermoplastic polyurethane having the same composition except without the fumed silica. Alternatively or in addition, the thermoplastic polyurethane composition has a resilience no more than 4% less than that that of a control thermoplastic polyurethane with the same composition except without silica. Alternatively or in addition, the thermoplastic polyurethane may have a compression set (Ct), as measured by ASTM D-395, greater than that of a control thermoplastic polyurethane with the same composition except without silica.

The prepolymer composition may further include one or more surfactants, fillers, flame retardants, nucleating agents, solvents, antioxidants, lubricants, mold-release agents, dyes, pigments, plasticizers, or UV stabilizers. The polyol composition may include up to 15 wt % fumed silica.

In another aspect, a thermoplastic polyurethane is produced according to any combination or subcombination of the method described above. The thermoplastic polyurethane may be molded. The thermoplastic polyurethane may include up to 10 wt % of the fumed silica. The thermoplastic polyurethane may have an elongation at break that is higher than that of a control thermoplastic polyurethane having the same composition except without the fumed silica. Alternatively or in addition, the thermoplastic polyurethane may have a resilience no more than 4% less than that of a control thermoplastic polyurethane with the same composition except without silica. Alternatively or in addition, the thermoplastic polyurethane may have a compression set (Ct), as measured by ASTM D-395, greater than that of a control thermoplastic polyurethane with the same composition except without silica.

Alternatively or in addition, a thermoplastic polyurethane composition has a density of at least 0.8 g/mL and includes particulate fumed silica having C1-C8 alkylsilyl groups or acrylate or methacrylate ester groups at its surface. The thermoplastic polyurethane may be molded. The thermoplastic polyurethane has an elongation at break that is higher than that of a control thermoplastic polyurethane having the same composition except without the fumed silica.

Alternatively or in addition, the thermoplastic polyurethane may have a resilience no more than 4% less than that of a control thermoplastic polyurethane with the same composition except without silica. Alternatively or in addition, the thermoplastic polyurethane may have a compression set (Ct), as measured by ASTM D-395, greater than that of a control thermoplastic polyurethane with the same composition except without silica.

The fumed silica may be present in an amount from 0.1 wt % to 10 wt % and may have a surface area from 50 m²/g to 400 m²/g and may have C1-C3 alkylsilyl groups on the surface. The thermoplastic polyurethane may further include one or more surfactants, fillers, flame retardants, nucleating agents, solvents, antioxidants, lubricants, mold-release agents, dyes, pigments, plasticizers, or UV stabilizers.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIG. 1 is a graph showing the Shore A hardness for TPU materials produced according to an embodiment of the invention with silicas at various loadings (stippled=0 wt %, horizontal lines=0.63%, checkerboard=3.17%, diagonal lines=6.44%)

FIG. 2 is a graph showing the resilience for TPU materials produced according to an embodiment of the invention with silicas at various loadings (stippled=0 wt %, horizontal lines=0.63%, checkerboard=3.17%, diagonal lines=6.44%).

FIG. 3 is a graph showing the modulus for TPU materials produced according to an embodiment of the invention with silicas at various loadings (stippled=0 wt %, horizontal lines=0.63%, checkerboard=3.17%, diagonal lines=6.44%).

FIG. 4 is a graph showing the elongation at break for TPU materials produced according to an embodiment of the invention with silicas at various loadings (stippled=0 wt %, horizontal lines=0.63%, checkerboard=3.17%, diagonal lines=6.44%).

FIG. 5 is a graph showing the toughness for TPU materials produced according to an embodiment of the invention with silicas at various loadings (stippled=0 wt %, horizontal lines=0.63%, checkerboard=3.17%, diagonal lines=6.44%).

FIG. 6 is a graph showing the abrasion resistance for TPU materials produced according to an embodiment of the invention with silicas at various loadings (stippled=0 wt %, horizontal lines=0.63%, checkerboard=3.17%, diagonal lines=6.44%).

FIG. 7 is a graph showing the tear strength for TPU materials produced according to an embodiment of the invention with silicas at various loadings (stippled=0 wt %, horizontal lines=0.63%, checkerboard=3.17%, diagonal lines=6.44%).

FIG. 8 is a graph showing the compression set (Ct) for TPU materials produced according to an embodiment of the invention with silicas at various loadings (narrow spaced horizontal lines=no silica; stippled=Example 1, wide spaced horizontal lines=Example 2; diagonal lines=Example 3).

FIG. 9 is a graph showing the heat resistance for TPU materials produced according to an embodiment of the invention with silicas at various loadings (stippled=0 wt %, horizontal lines=0.63%, checkerboard=3.17%, diagonal lines=6.44%).

FIG. 10 is a graph showing the Shore A hardness for TPU materials produced using melt mixing with silicas at various loadings (stippled: none; horizontal lines: low loading; checkerboard: medium loading; diagonal lines: highest loading).

FIG. 11 is a graph showing the modulus hardness for TPU materials produced using melt mixing with silicas at various loadings (stippled: none; horizontal lines: low loading; checkerboard: medium loading; diagonal lines: highest loading).

FIG. 12 is a graph showing the elongation at break for TPU materials produced using melt mixing with silicas at various loadings (stippled: none; horizontal lines: low loading; checkerboard: medium loading; diagonal lines: highest loading).

FIG. 13 is a graph showing the resilience for TPU materials produced using melt mixing with silicas at various loadings (stippled: none; horizontal lines: low loading; checkerboard: medium loading; diagonal lines: highest loading).

### DETAILED DESCRIPTION OF THE INVENTION

In one embodiment, a method of producing a thermoplastic polyurethane includes combining up to 15 wt % fumed silica with a first polyol having a number average molecular weight of 300-5000 to form a silica-polyol dispersion. The silica-polyol dispersion is combined with an aromatic, cycloaliphatic, or araliphatic diisocyanate and allowed to polymerize. The fumed silica has a surface area of at least 50 m²/g and is hydrophobized using a surface treatment that leaves C1-C8 alkylsilyl groups or acrylate or methacrylate ester groups, preferably C1-C3 alkylsilyl groups, at the surface. The resulting thermoplastic elastomer has a very low concentration of air bubbles or voids, as evidenced by a density no less than 0.8 g/mL, for example, at least 1 g/mL or from 1 to 2 g/mL.

Appropriate isocyanates for use with the formulations and processes provided herein include organic diisocyanates that can form crystalline domains in a thermoplastic polyurethane. Formation of crystalline domains is especially promoted by aromatic isocyanates, but cycloaliphatic and araliphatic isocyantes may be used as well. Exemplary isocyanates such as m-phenylene diisocyanate, 2,4- and/or 2,6-toluene diisocyanate (TDI), the various isomers of diphenylmethanediisocyanate (MDI), cyclohexane-1,4-diisocyanate, hexahydrotoluene diisocyanate, hydrogenated MDI (H12 MDI), naphthylene-1,5-diisocyanate, methoxyphenyl-2,4-diisocyanate, 4,4′-biphenylene diisocyanate, 3,3′-dimethoxy-4,4′-biphenyl diisocyanate, 3,3′-dimethyldiphenylmethane-4,4′-diisocyanate, 3,3′-dimethyldiphenyl diisocyanate, 1,2-diphenylethane diisocyanate, phenylene diisocyanate, 1-isocyanato-3,3,5-trimethyl-5-isocyanatomethyl-cyclohexane (isophorone diisocyanate, IPDI), 1,4-bis(isocyanatomethyl)cyclohexane, 1,3-bis(isocyanatomethyl)cyclohexane (HXDI), 1,4-cyclohexane diisocyanate, 1-methyl-2,4-cyclohexane diisocyanate, 1-methyl-2,6-Dicyclohexylmethane di isocyanate, 4,4′-dicyclohexylmethane diisocyanate (H12MDI), 2,4′-dicyclohexylmethane diisocyanate, 2,2′-dicyclohexylmethane-diisocyanate and mixtures thereof

Appropriate polymer polyols for use with the formulations and processes provided herein include both polyether polyols and polyester polyols and other polymer polyols known to those of skill in the art. Suitable polyols have a molecular weight, preferably number average molecular weight, from 300-5000, for example, 500-4000 or 1000-3000 and typically have a functionality of 2 (i.e., diols). If the polyol has a molecular weight less than 300, the thermoplastic elastomer composition may lose elasticity as a result of insufficiently long soft polyether segments. Above 5000, it may become more difficult to achieve the phase separation that generates the soft and hard phases, and/or it may become more difficult to balance the hard and soft properties that provide the unique blend of elasticity and plasticity (e.g., processability using plastic molding equipment). Polyether polyols may be obtained by polymerization of alkylene oxides, for example, C2-C4 alkylene oxides such as ethylene oxide, 1,2-propylene oxide, 1,3-propylene oxide, 1,2- or 2,3-butylene oxide, tetramethylene oxide, and/or tetrahydrofuran.

Polyester polyols may be obtained by reacting a small molecule polyol with a polyester. Exemplary small molecule polyols include but are not limited to ethylene glycol, diethylene glycol, triethylene glycol, 1, 2-propylene glycol, trimethylene glycol, tetramethylene glycol, hexamethylene glycol, glycerol, diglycerol, sorbitol, pentaerythritol, sucrose, and bisphenol A. Exemplary polyesters include any polyester known to those of skill in the art for use in thermoplastic polyurethanes and may be produced from an organic dicarboxylic acid, for example, a C2-C12 unbranched aliphatic chain terminated with carboxylic acid groups, and a di- or tri-functional alcohol, for example C2-C12 alkylene glycols or polyether alcohols. Alternatively or in addition, polyesters for use with the polyester polyol may be produced by polymerization of lactones or hydroxycarboxylic acids.

A chain extender is also typically incorporated into the thermoplastic polyurethane. Suitable chain extenders include any known to those of skill in the art for use in TPU, e.g., C2-C6 glycols, for example, ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol, and neopentyl glycol.

Fumed silica is typically produced via a pyrogenic process in which a gaseous feedstock comprising a fuel, e.g., methane or hydrogen, oxygen, and a volatile silicon compound is fed into a burner. Water formed by the combustion of the fuel in oxygen reacts with the volatile silicon compound either in liquid or gaseous form to produce silicon dioxide particles. These particles coalesce and aggregate to formed fumed silica. Non-limiting examples of fumed silicas include CAB-O-SIL® fumed silica available from Cabot Corporation, HDK® fumed silica products available from Wacker Chemie AG, and AEROSIL® fumed silica available from Evonik Industries, Essen, Germany.

During formation of thermoplastic polyurethane, it is desirable to balance the properties of the formulation to coordinate the formation of hydrogen bonds between the silica and the polymer with the formation of the polymer itself. Increasing the surface area of the silica increases the available surface area to interact with the polymer. Thus, in preferred embodiments, the fumed silica used herein has a surface area, as measured by nitrogen adsorption (ASTM D1993), of at least 50 m²/g, for example, at least 90 m²/g, at least 150 m²/g, at least 175 m²/g, at least 200 m²/g, 50 to 400 m²/g, or 175 to 300 m²/g, 80 to 250 m²/g, or 150 to 200 m²/g.

As produced, fumed silica is hydrophilic, with multiple Si—OH groups on the surface. These silanol groups can interact with alcohols via hydrogen bonding and with the oxyalkylene groups of polyethers via acid-base interactions. In combination with the thixotropy provided by the branched structure of the silica, the interaction of the silanol groups with hydrophilic components of the prepolymer formulation may increase viscosity. Hydrophobization of the silica endcaps a proportion of the silanol groups, reducing the thickening effect. Moreover, the hydrophobizing treatment preferably does not interfere with the polymerization reaction.

It has been unexpectedly found that fumed silica that is hydrophobized with an agent that leaves short alkylsilyl groups on the surface influences the microstructure of the polymer, e.g., the arrangement of the hard and soft phases, without adversely affecting the viscosity of the prepolymer composition, thereby enhancing mechanical properties. Without being bound by any particular theory, it is believed that the short alkylsilyl groups still allow hydrogen bonding of the remaining unreacted silanols at the silica surface with the polyol components. In contrast, surface treatments with larger alkyl or siloxyl chains on the surface adversely increase the viscosity of the prepolymer. Suitable surface treatments leave C1-C3 alkylsilyl groups on the surface, for example, trimethylsilyl, vinyl silyl, dimethylsilyl, ethylsilyl, or methylethylsilyl groups. The silyl group may be attached to the surface of the fumed silica by one, two, or three siloxane bonds or may be linked to one or two adjacent alkylsilane groups via a siloxane bond. Surface treatments that leave longer groups, e.g., up to C5 or C8, and/or vinyl, acrylate ester, or methacrylate ester groups may also be employed. The appropriate length of the alkyl chain (either by itself or as a linker between the silicon atom and a vinyl, acrylate, or methacrylate group) will vary with the ratio of long chain polyols and short chain polyols and should be controlled to prevent the silica from causing yield stress or reducing viscosity in the prepolymer composition or any components with which the silica is mixed. The silica particles should not be so hydrophobic that they form a separate network in the polyol, thereby increasing viscosity, rather than primarily interacting with the polyol or polyether molecules.

In certain embodiments, the fumed silica may be hydrophobized with a silazane such as hexamethyl disilazane or an alkylsilane such as dimethyldichlorosilane, methyltrimethoxysilane, methyl trichlorosilane, methyltrimethoxysilane, methyltriethoxysilane, dimethyldimethoxysilane, dimethyldiethoxysilane, trimethylchlorosilane, trimethylmethoxysilane, trimethylethoxysilane, ethyltriethoxysilane, ethyltrichlorosilane, ethyltrimethoxysilane, propyltrichlorosilane, propyltrimethoxysilane, propyltriethoxysilane, ethylmethyldichlorosilane, and other C1-C3 linear and branched alkyl silanes.

The components of the thermoplastic polyurethane may be combined and polymerized using any method known to those of skill in the art. Preferably, the silica is combined with the components of the thermoplastic polyurethane prior to polymerization. More preferably, the fumed silica is dispersed in polyol according to methods known to those of skill in the art, which may then be combined with one or more remaining non-isocyanate components of the polyurethane prior to being combined with the polyisocyanate and polymerized. Because the silica does not provide reinforcement on its own, small amounts, as low as 0.1 wt %, for example, from 0.1 wt % to 10 wt %, for example, 0.5 wt % to 7 wt % or 1 wt % to 5 wt %, may be used in the thermoplastic polyurethane. The polyol may contain up to 15 wt % fumed silica, for example, from 0.2 wt % to 12 wt %, from 0.5 wt % to 10 wt %, from 1 wt % to 7 wt %, from 2 wt % to 5 wt %, from 3 wt % to 8 wt %, or from 5 wt % to 13 wt %.

The use of fumed silica surface modified with short hydrophobizing groups in an in-situ polymerization process in which the silica is combined with polyol prior to polymerization provides benefits to molded parts, especially compression molded parts, that fumed silica that is simply masterbatched with the thermoplastic polyurethane cannot provide. In some embodiments, the thermoplastic polyurethane or molded thermoplastic polyurethane has an elongation at break, as measured according to ASTM D412, that is greater than that of a similar material with the same composition except without silica, for example, at least 4% higher, at least 5% higher, at least 10% higher, at least 15% higher, at least 20% higher, or up to 60% higher. Alternatively or in addition, the thermoplastic polyurethane or molded thermoplastic polyurethane may have a resilience, as measured according to ASTM D-2632 (Bashore rebound), no more than 4% less than that that of a similar material with the same composition except without silica, for example, no more than 2% less, no more than 0% less, up to 3% more, up to 6% more, up to 9% more, up to 12% more, up to 15% more, or up to 18% more. Alternatively or in addition, the thermoplastic polyurethane or molded thermoplastic polyurethane may have a compression set (Ct), as measured by ASTM D-395, greater than that of a similar material with the same composition except without silica, for example, at least 10% greater, at least 15% greater, at least 20% greater, at least 30% greater, or up to 90% greater.

Additional components known to those of skill in the art for use in thermoplastic polyurethanes may also be employed. Exemplary additives include but are not limited to surfactants, fillers, flame retardants, nucleating agents, solvents, antioxidants, lubricants, mold-release agents, dyes, pigments, plasticizers, and UV stabilizers. The thermoplastic polyurethanes may be combined with additional polymers as well.

Any composition of thermoplastic polyurethane may benefit from the teachings herein. Exemplary compositions of thermoplastic polyurethanes are given in WO2012069264, EP111122, EP922552, and U.S. Pat. No. 8,993,690, the contents of which are incorporated herein by reference.

The thermoplastic polyurethanes provided according to the various embodiments herein can be used as midsoles and outsoles in footwear and in wire insulation, hoses, films, wheels and tires, and drilling/mining screens.

The present invention will be further clarified by the following examples which are intended to be only exemplary in nature.

### EXAMPLES

### Example 1

Fumed silica having a surface area of about 90 m²/g was surface treated with hexamethyldisilazane, leaving trimethylsilyl groups at the surface. The surface treated silica was dispersed in polytetramethylene glycol having a molecular weight of 1000 (PTMG 1000 with 0.05-0.07 BHT as stabilizer, Aldrich Chemistry) with a FlackTek DAC600 Speedmixer to make a 10 wt % dispersion. This dispersion was demoisturized in a 1 L reaction kettle under agitation and a vacuum of <2 mm Hg for five hours. The demoisturized dispersion was used to prepare 100 g each of 1 and 5 wt % dispersions by dilution with PTMG 1000 (with 0.05-0.07 BHT as stabilizer, Aldrich Chemistry) in a 300 g speed mixing cup using a Flacktek DAC 400 FV speedmixer at 2200 rpm.

TPUs were prepared using 1,4-butanediol (Nexeo Solutions) as a chain extender and diphenylmethane 4,4′-diisocyanate (4,4′-MDI, Mondur MB, Covestro) as an isocyanate at 1/1/2 polyol/chain extender/isocyanate equivalent ratio and isocyanate index of 1.02, with Dabco T-12 dibutyltin dilaurate catalyst (Air Products). The 1,4-butanediol was dried in a 250 mL round bottom flask at 70° C. under vacuum of <2 mm Hg and magnetic stirring prior to use. The compositions are listed in Table 1 below.

TABLE 1

| | Example 1-1 | Example 1-2 | Example 1-3 |
|---|---|---|---|
| Wt % silica in | 0.63 | 3.17 | 6.44 |
| TPU | | | |
| Neat PTMG (g) | — | — | — |
| 1% silica | 37.56 | — | — |
| dispersion in | | | |
| PTMG (g) | | | |
| 5% silica | — | 37.56 | — |
| dispersion in | | | |
| PTMG (g) | | | |
| 10% silica | — | — | 37.56 |
| dispersion in | | | |
| PTMG (g) | | | |
| 1,4-butanediol | 3.36 | 3.30 | 3.22 |
| (g) | | | |
| 4,4′MDI (g) | 18.97 | 18.61 | 18.14 |
| Catalyst (g) | 0.00202 | 0.00220 | 0.00220 |

TPUs were prepared using the following procedure: degassed preheated polyol and a chain extender are weighed into a Speed Mixer cup and mixed for at least 20 seconds at 2200 rpm using a Speed Mixer (Flacktek DAC 400) and subsequently heated for 15 minutes in an air-circulating oven at 100° C. Liquid isocyanate conditioned at 70° C. is added via syringe to the mixture of polyol and the chain extender. All components are mixed via Speed Mixer at 2200 rpm for 30 seconds and transferred into an aluminum mold covered with Teflon sheet that is preheated at 120° C. Gel time, measured as string formation, is adjusted to about 1-2 minutes by addition of Dabco T-12 catalyst (Table 4). At the gel time, the mold is closed and TPUs were cured for 2 hours at 120° C. and approximately 20,000 psi pressure. Afterwards, the samples are post-cured for 20 hours at 100° C. in an air-circulation oven. Following post-curing, the samples are aged for seven days at room conditions prior to testing. Round samples and sheets compressed in a Carver press were prepared to test the properties of the TPUs.

### Example 2

Fumed silica having a surface area of about 250 m²/g was surface treated with hexamethyldisilazane, leaving trimethylsilyl groups at the surface. TPUs were prepared with the resulting silica as described in Example 1 except that the various components were mixed for 40 seconds at 2200 rpm prior to transfer into the mold. The compositions are listed in Table 2 below.

TABLE 2

| Sample | Comparative | Example 2-1 | Example 2-2 | Example 2-3 |
|---|---|---|---|---|
| Wt % silica in | 0 | 0.63 | 3.17 | 6.44 |
| TPU | | | | |
| Neat PTMG (g) | 37.30 | — | — | — |
| 1% silica | — | 37.48 | — | — |
| dispersion in | | | | |
| PTMG (g) | | | | |
| 5% silica | — | — | 38.17 | — |
| dispersion in | | | | |
| PTMG (g) | | | | |
| 10% silica | — | — | — | 39.08 |
| dispersion in | | | | |
| PTMG (g) | | | | |
| 1,4-butanediol | 3.42 | 3.39 | 3.29 | 3.15 |
| (g) | | | | |
| 4,4′-MDI (g) | 19.29 | 19.13 | 18.54 | 17.77 |
| Catalyst (g) | 0.0011 | 0.0022 | 0.0022 | 0.0019 |

### Example 3

Fumed silica having a surface area of about 220 m²/g was surface treated with dimethyldichlorosilane, leaving dimethylsilyl groups at the surface. TPUs were prepared with the resulting silica as described in Example 1, except that the various components were mixed for 40 seconds at 2200 rpm prior to transfer into the mold. The compositions are listed in Table 3 below.

TABLE 3

| Sample | Example 3-1 | Example 3-2 | Example 3-3 |
|---|---|---|---|
| Wt % silica in | 0.67 | 3.17 | 6.44 |
| TPU | | | |
| 1% silica | 37.46 | — | — |
| dispersion in | | | |
| PTMG (g) | | | |
| 5% silica | — | 38.07 | — |
| dispersion in | | | |
| PTMG (g) | | | |
| 10% silica | — | — | 38.87 |
| dispersion in | | | |
| PTMG (g) | | | |
| 1,4-butanediol | 3.39 | 3.30 | 3.18 |
| (g) | | | |
| 4,4′-MDI (g) | 19.15 | 18.63 | 17.95 |
| Catalyst (g) | 0.0019 | 0.0019 | 0.0022 |

### Example 4

The TPU samples from Examples 1, 2 and 3 were analyzed for mechanical properties as described in Table 4 below.

TABLE 4

| | |
|---|---|
| Hardness @ RT | ASTM D-2240, Shore A |
| Resilience (Bashore rebound) | ASTM D2632 (Bashore |
| | Resiliometer) |
| Tensile stress-strain | ASTM D412 (Instron |
| properties (elongation | 5500R, Model 1122) |
| at break, modulus, | |
| toughness) | |
| Heat resistance: Tensile | ASTM D412 (Instron |
| strength up to 400% | 5500R, Model 1122 |
| extension @50° C. | with Heat Chamber) |
| Tear Strength - Graves Die C | ASTM D624, (Instron |
| | 5500R, Model 1122) |
| Compression set at 70° C. | ASTM D-395 |
| Abrasion Resistance | ASTM D 1044 (H22 |
| | wheels, weight load |
| | 500 g, 2000 cycles, |
| | Standard Abrasion |
| | Tester Model 503) |

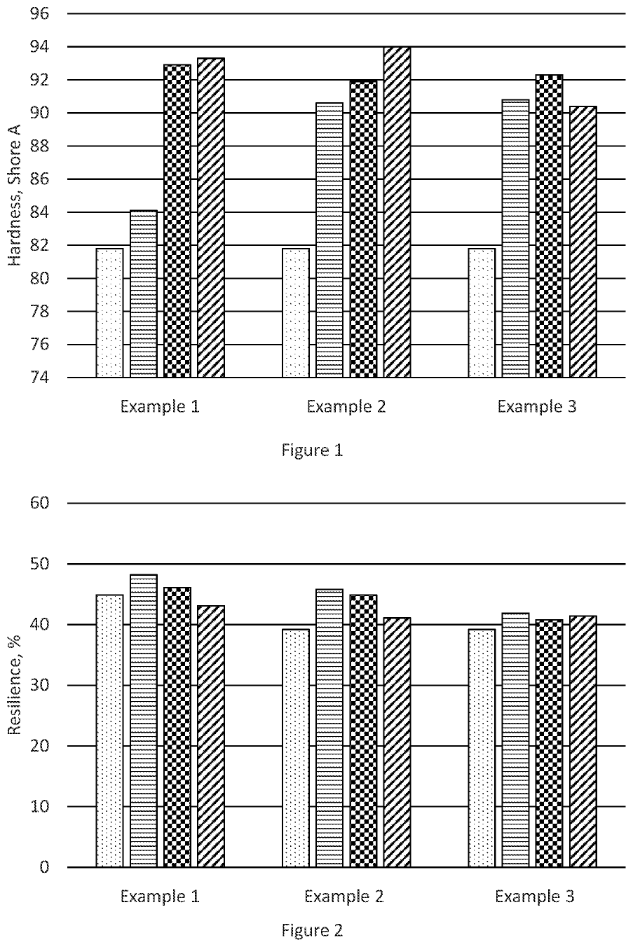

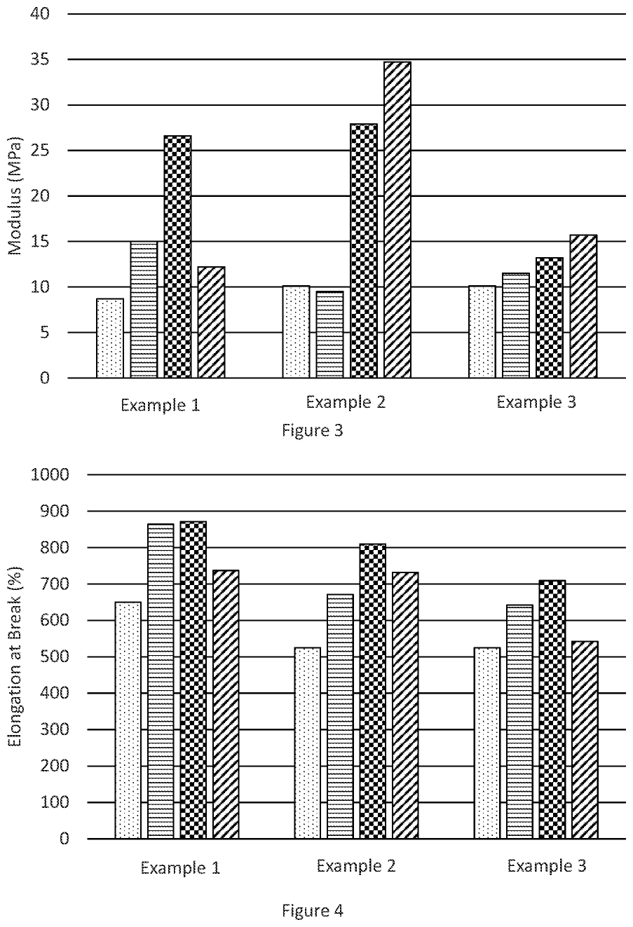

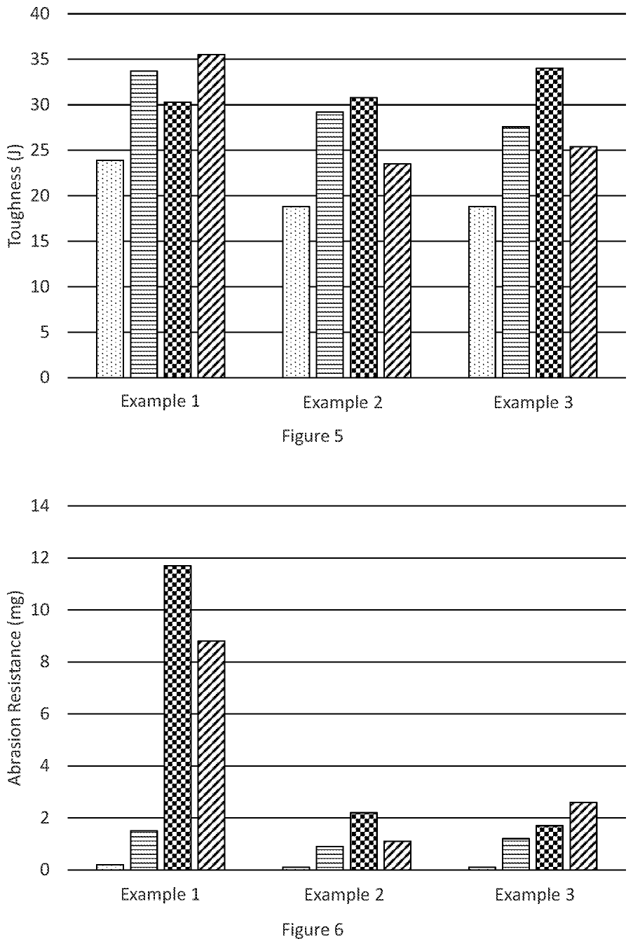

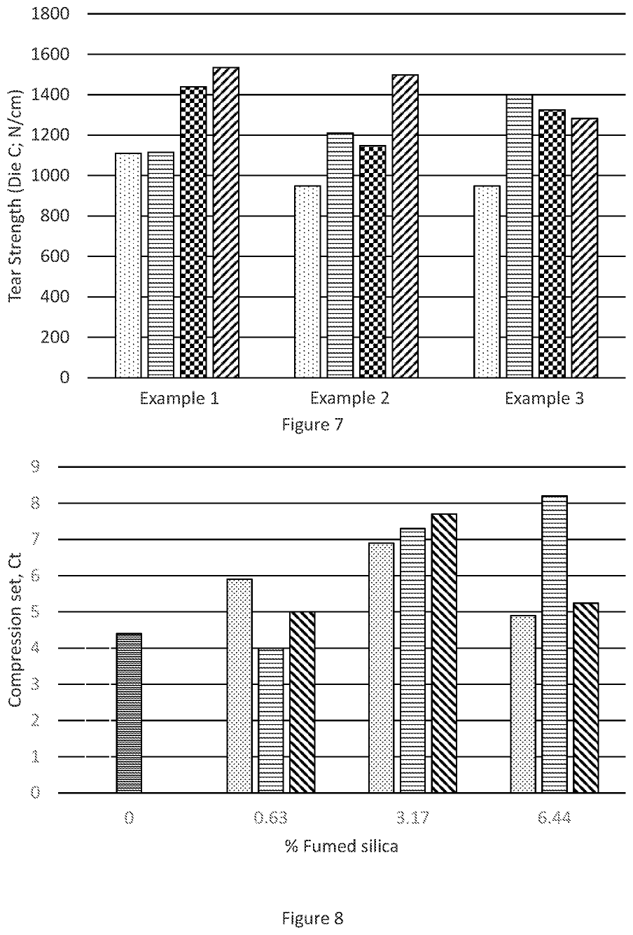

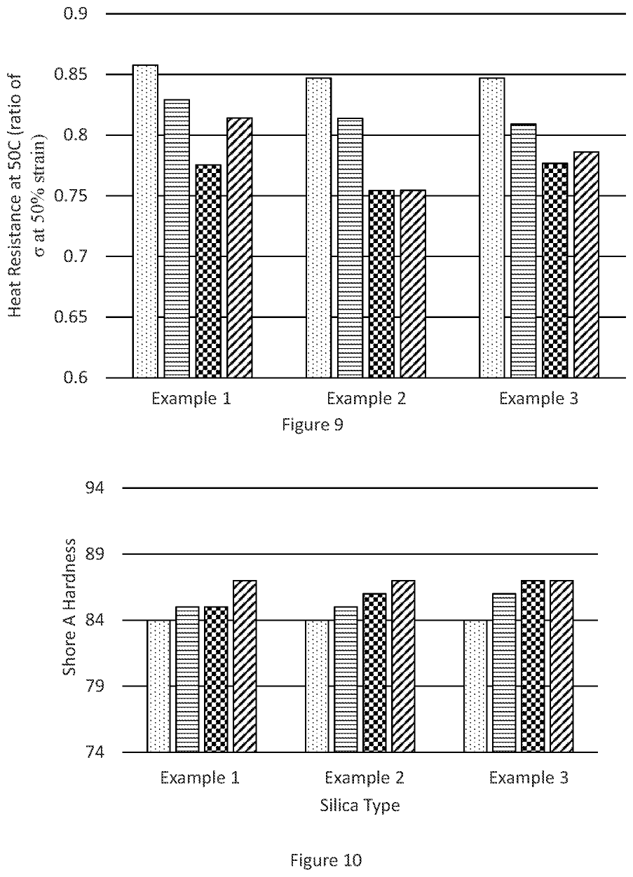

As shown in FIGS. 1 and 2, Shore A hardness increased with silica loading for all three silicas, and resilience either remained unchanged or increased with the use of all three silicas with respect to the comparative example. Modulus and elongation at break (FIGS. 3 and 4) also increased with respect to the unfilled TPU, reaching a maximum at 3.17% loading. As a result, silica also improves toughness (area under the stress/strain curve) (FIG. 5) with respect to the comparative example, reaching a maximum at 3.17 wt % loading for the higher surface area silicas and 6.44 wt % loading with use of lower surface area silica of Example 1. Abrasion resistance (FIG. 6) for filled TPU systems was acceptable, although weight loss values were higher than for the softer, unfilled TPU system. Tear strength (Die C) (FIG. 7) was improved by the addition of silica. The compression set (Ct) (FIG. 8) for all TPU systems was low and was not dramatically impacted by the addition of hydrophobic fumed silica. Likewise, the heat resistance (FIG. 9) of the TPU systems was not dramatically impacted by the addition of hydrophobic fumed silica. Heat resistance is reported as the ratio of the tensile stress at 50% strain at 50° C. and room temperature (i.e., σₕₒₜ/σ_{cool}).

### Example 5

TPUs from Examples 1, 2, and 3 were combined with tetrahydrofuran (THF) at 10 wt %. Both the comparative and the silica-filled samples dissolved, indicating that the fumed silica does not exhibit significant covalent crosslinking in TPUs. In addition, TPUs from Examples 2 and 3 were analyzed by differential scanning calorimetry (Universal V4 instrument from TA Instruments) (Table 5). The glass transition temperature (Tg) was reduced and the melt transition temperature (Tm) increased with increasing silica concentration, suggesting that fumed silica is present in both the soft segments (which dictate Tg) and the hard segments (which dictate Tm) of the polymer. The enthalpy of crystallization, calculated by integrating the area encompassed between the crystallization peak and the baseline of the DSC thermogram, also increased with silica loading. The change in Tm and crystallization enthalpy suggest that the silica influences the morphology of the hard segments of the TPU, with increased partitioning of the MDI segments to the hard segments of the TPU and reduced amounts of the MDI in the soft and mixed phases of the TPU. As the tensile behavior of the TPU is driven by the motion of polymer chains in the hard, crystalline segments, which behave similar to reinforcing fillers, this change in morphology would be expected to influence the mechanical properties of the TPU. The change in MDI distribution in the TPU is confirmed by solid state ¹³C CPMAS NMR. Table 5A shows the shift in intensity from sharp ¹³C signals to broad signals in samples with varying concentrations of the silica of Example 1. Sharp signals indicate short relaxation times and are generated by MDI in soft segments, while broad signals indicate long relaxation times and are generated by MDI in hard segments. Thus, the increase in the molar contribution to the broad signals indicates increased MDI presence in the hard segments.

TABLE 5

| Silica Type | | Example 2 | | | Example 3 | | |
|---|---|---|---|---|---|---|---|
| Silica | 0% | 0.67% | 3.17% | 6.44% | 0.67% | 3.17% | 6.44% |
| loading | | | | | | | |
| Tg (° C.) | −27.1 | −36.1 | −35.3 | −36.1 | −34.2 | −33.4 | −32.7 |
| Tm (° C.) | 169.5 | 178.6 | 181.4 | 195.6 | 185.6 | 190.1 | 181.4 |

TABLE 5A

% silica

| | | | |
|---|---|---|---|
| 0 | 0.67 | 3.2 | 6.44 |

| | |
|---|---|
| Type of signal | Relative signal contribution, mol % |

| | | | | |
|---|---|---|---|---|
| Sharp | 26 | 17 | 17 | 13 |
| Middle | 29 | 23 | 16 | 23 |
| Broad | 46 | 61 | 67 | 64 |

### Example 6

Irogran A85 P4394 thermoplastic polyurethane (Huntsman) was compounded with the silicas of Examples 1-3 at the loading levels specified in Table 6 below. Fumed silica was incorporated into the commercial TPU by melt blending using a Leistritz iMaxx intermeshing co-rotating twin-screw extruder with laboratory scale modular screw profile design (screw diameter=27 mm, length to diameter ratio L/D=48). Commercial TPU was fed into the hopper (main throat) using a Coperion K-Tron S60 gravimetric feeder, while silica was introduced in the TPU melt stream via a Coperion K-Tron KT20 gravimetric side-feeder.

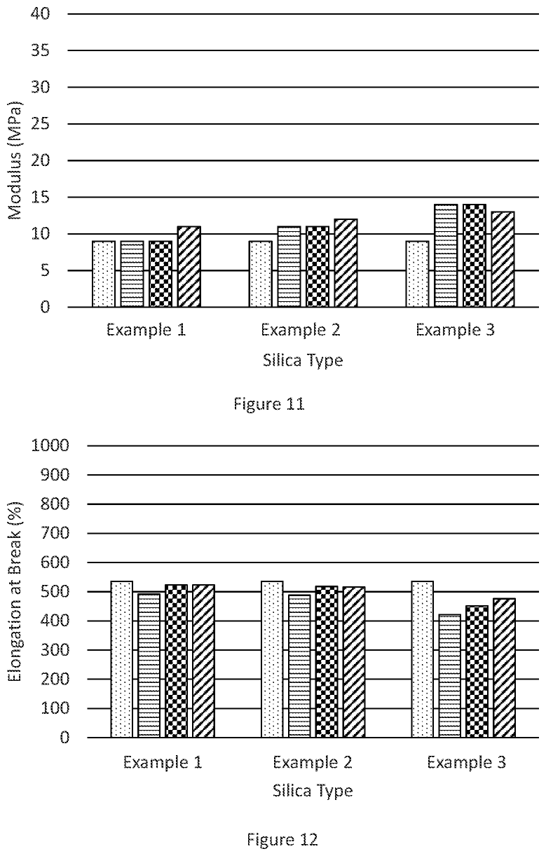

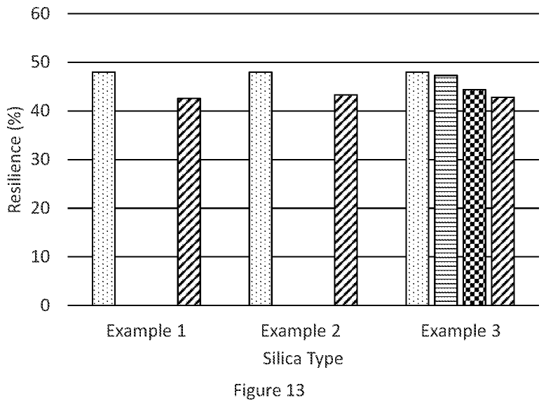

The temperature profile for silica compounding from feeding zone to die exit was as follows: 165-170-170-170-170-170-170-170-170-160-160-160° C. A screw speed of 350 min⁻¹ and a throughput of 15 kg/hr were used for all compounds. Extrudates were cooled in a water bath and dried by air before being pelletized. After melt processing, extruded materials were dried overnight at 70° C. in a dehumidifying dryer. Silica-TPU composites were then injection-molded using Wittmann-Battenfeld Smart Power 60/210 injection molding equipment. The mechanical properties of the resulting thermoplastic were measured as described above. No resilience data were measured at low or medium loading levels for the silica of Example 1 or Example 2. The Shore A hardness, modulus, elongation at break, and resilience are depicted in FIGS. 10-13 (neat polymer control indicated by stippling). These figures show that the effect of fumed silica in a melt mixed composite is not as beneficial as when the fumed silica is combined with the TPU formulation prior to polymerization.

TABLE 6

| | Loading level (wt %) (FIG. 10-13 legend) | | |
|---|---|---|---|
| | Low | Medium | High |
| Silica type | (horizontal lines) | (checkerboard) | (diagonal lines) |
| Example 1 | 0.5 | 2.8 | 5.8 |
| Example 2 | 0.5 | 2.6 | 5.3 |
| Example 3 | 0.7 | 2.8 | 5.9 |

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of producing thermoplastic polyurethane, comprising:
providing a polyol composition comprising at least a first polyol, the first polyol having a number average molecular weight of 300 to 5000, and up to 15 wt % of a fumed silica having a surface area of at least 50 m²/g, wherein the fumed silica has C1-C8 alkylsilyl groups or acrylate or methacrylate ester groups at its surface;
combining the polyol composition and an aromatic, cycloaliphatic, or araliphatic diisocyanate to form a prepolymer composition; and
allowing the prepolymer composition to polymerize to form a thermoplastic polyurethane having a density no less than 0.8 g/mL.

2. The method of claim 1, wherein allowing comprises adding a catalyst to the prepolymer composition.

3. The method of claim 1, wherein the prepolymer composition further comprises a chain extender.

4. The method of claim 1, wherein the fumed silica has a surface area of 50 to 400 m²/g.

5. The method of claim 1, wherein the fumed silica has C1-C3 alkylsilyl groups on the surface.

6. The method of claim 1, wherein the thermoplastic polyurethane composition has an elongation at break that is higher than that of a control thermoplastic polyurethane having the same composition except without the fumed silica.

7. The method of claim 1, wherein the thermoplastic polyurethane composition has a resilience no more than 4% less than that that of a control thermoplastic polyurethane with the same composition except without silica.

8. The method of claim 1, wherein the thermoplastic polyurethane has a compression set (Ct) greater than that of a control thermoplastic polyurethane with the same composition except without silica.

9. The method of claim 1, wherein the prepolymer composition further includes one or more surfactants, fillers, flame retardants, nucleating agents, solvents, antioxidants, lubricants, mold-release agents, dyes, pigments, plasticizers, or UV stabilizers.

10. The method of claim 1, wherein the polyol composition comprises up to 15 wt % fumed silica.

11. The method of claim 1, further comprising molding the thermoplastic polyurethane.

12. A thermoplastic polyurethane produced according to the method of claim 1.

13. The thermoplastic polyurethane of claim 12, comprising up to 10 wt % of the fumed silica.

14. The thermoplastic polyurethane of claim 12, having an elongation at break that is higher than that of a control thermoplastic polyurethane having the same composition except without the fumed silica.

15. The thermoplastic polyurethane of claim 12, having a resilience no more than 4% less than that of a control thermoplastic polyurethane with the same composition except without silica.

16. The thermoplastic polyurethane of claim 12, wherein the thermoplastic polyurethane has a compression set (Ct) greater than that of a control thermoplastic polyurethane with the same composition except without silica.

17. The thermoplastic polyurethane of claim 12, wherein the thermoplastic polyurethane is molded.

18. A thermoplastic polyurethane composition having a density of at least 0.8 g/mL and comprising particulate fumed silica having C1-C8 alkylsilyl groups or acrylate or methacrylate ester groups at its surface, wherein the thermoplastic polyurethane has an elongation at break that is higher than that of a control thermoplastic polyurethane having the same composition except without the fumed silica.

19. The thermoplastic polyurethane of claim 18, wherein the thermoplastic polyurethane has a resilience no more than 4% less than that of a control thermoplastic polyurethane with the same composition except without silica.

20. The thermoplastic polyurethane of claim 18, wherein the thermoplastic polyurethane has a compression set (Ct) greater than that of a control thermoplastic polyurethane with the same composition except without silica.

21. The thermoplastic polyurethane of claim 18, wherein the fumed silica is present in an amount from 0.1 wt % to 10 wt %.

22. The thermoplastic polyurethane of claim 18, wherein the fumed silica has a surface area from 50 m²/g to 400 m²/g.

23. The thermoplastic polyurethane of claim 18, further comprising one or more surfactants, fillers, flame retardants, nucleating agents, solvents, antioxidants, lubricants, mold-release agents, dyes, pigments, plasticizers, or UV stabilizers.

24. The thermoplastic polyurethane of claim 18, wherein the fumed silica has C1-C3 alkylsilyl groups on the surface.

25. The thermoplastic polyurethane of claim 18, wherein the thermoplastic polyurethane is molded.
